(19) United States
(12) Patent Application Publication
(10) Pub. No.: US 2014/0180828 A1
(43) Pub. Date: Jun. 26, 2014

(54) INFORMATION PROCESSING APPARATUS, INFORMATION PROCESSING METHOD, INFORMATION PROCESSING PROGRAM, AND RECORDING MEDIUM HAVING STORED THEREIN INFORMATION PROCESSING PROGRAM

(71) Applicant: Narutaka Iwasaki, Shinagawa-ku (JP)

(72) Inventor: Narutaka Iwasaki, Shinagawa-ku (JP)

(73) Assignee: RAKUTEN, INC., Shinagawa-ku, Tokyo (JP)

(21) Appl. No.: 14/235,263

(22) PCT Filed: Feb. 24, 2012
(86) PCT No.: PCT/JP2012/054562

§ 371 Date: Jan. 27, 2014

(30) Foreign Application Priority Data
Jul. 29, 2011 (JP) 2011-167363

(51) Int. Cl. G06Q 30/02

(52) U.S. Cl. CPC G06Q 30/0272
USPC 705/14.68

(57) ABSTRACT

Provided are an information processing apparatus, an information processing method, an information processing program, and a recording medium having stored therein the information processing program, which can perform control such that a display time of content information for a user is equal to or exceeds a time desired by a provider of the content information, or approaches the desired time as close as possible. The information processing apparatus performs control such that a display time for which content information of a time count target is displayed within a display area is counted, and the content information is continuously or intermittently displayed within the display area until the counted display time exceeds a display guarantee setting value set to the content information of the time count target.

### TECHNICAL FIELD

The present invention relates to a technical field of systems and the like which provide a terminal device with a web page that displays content information via a network.

### BACKGROUND ART

In the past, there have been known systems that provide a terminal device with a web page via a network, the web page having a display area for posting advertisement content information. In such systems, an advertiser, who wants to post advertisement content information on the display area, for example, can pay an advertising fee to a site operator so as to post advertisement content information on the display area during a designated period corresponding to the payment amount. For example, in an advertisement distribution system disclosed in Patent Literature 1, a posting period of advertisement information transmitted to a terminal is stored in an advertisement information distribution server.

### PRIOR ART LITERATURE

### Patent Literature

Patent Literature 1: JP 2010-250835 A

### SUMMARY OF THE INVENTION

### Problem to be Solved by the Invention

In the conventional system, advertisement content information is certainly posted during a designated period, but there are cases where advertisement is not noticeable to a user for a time desired by an advertiser. Advertisement content information always followed by a page operation gives discomfort to a user, degrading an advertising effect.

Therefore, the present invention has been made in view of the above problems and is directed to provide an information processing apparatus, an information processing method, an information processing program, and a recording medium having stored therein the information processing program, which can perform control such that a display time of content information with respect to a user exceeds a time desired by a provider of the content information (e.g., an advertiser), or approaches the corresponding time as close as possible.

### Means for Solving the Problem

In order to solve the above problem, the invention according to claim 1 is an information processing apparatus comprising:

a counting means that counts a display time for which content information preset as a count target of a display time is displayed within a display area of a displaying means; and

a display controlling means that continuously or intermittently displays the content information within the display area until the display time counted by the counting means exceeds a set time preset to the content information.

According to the present invention, control can be performed such that the display time of the content information with respect to the user exceeds the time desired by the provider of the content information or approaches the corresponding time as close as possible.

The invention according to claim 2 is the information processing apparatus according to claim 1,

wherein the content information is transmitted from a server device for which sessions are established with a terminal device including the displaying means,

the information processing apparatus further comprises a first integrating means that integrates the display time, which is counted by the counting means, over the sessions, and

the display controlling means continuously or intermittently displays the content information within the display area until the display time integrated by the first integrating means exceeds the set time.

According to the present invention, the display time can be continuously counted in other sessions.

The invention according to claim 3 is the information processing apparatus according to claim 1, further comprising:

an acquiring means that acquires the display time counted by the counting means and user identification information for identifying a user of a terminal device, from the terminal device including the displaying means; and

a second integrating means that integrates the display time acquired by the acquiring means in association with the user identification information, and

the display controlling means continuously or intermittently displays the content information within the display area of the terminal device associated with the user identification information until the display time integrated by the second integrating means exceeds the set time.

According to the present invention, control can be performed such that the time for which more users browse the content information exceeds the time desired by the provider of the content information or approaches the corresponding time as close as possible.

The invention according to claim 4 is the information processing apparatus according to claim 3,

wherein the set time to be compared with the display time integrated by the second integrating means is set to more than a minimum time necessary when the user browses the content information.

According to the present invention, exposure time per user can exceed the display time capable of expecting the effect by the browsing.

The invention according to claim 5 is the information processing apparatus according to claim 1, further comprising a third integrating means that integrates the display time, which is counted by the counting means, while being gathered by a plurality of users,

wherein the display controlling means continuously or intermittently displays the content information within the display area until the display time integrated by the third integrating means exceeds the set time.

According to the present invention, it is possible to determine whether all the users have browsed the content information for more than the time desired by the provider of the content information.

The invention according to claim 6 is the information processing apparatus according to any one of claims 1 to 5,

wherein the content information is arranged on the web page displayed in the display area, and

when there is a user operation to shift the content information to the outside of the display area in a state in which the displaying of the web page is maintained, the display controlling means continuously or intermittently displays the content information within the display area until the display time counted by the counting means exceeds the set time.

According to the present invention, in a case where there is the user operation to shift the content information to the outside of the display area, control can be performed such that the display time exceeds the time desired by the provider of the content information or approaches the corresponding time as close as possible.

The invention according to claim 7 is the information processing apparatus according to any one of claims 1 to 6,

wherein the counting means stops counting the display time when a time for which a user operation is not performed on the display area displaying the content information exceeds a preset count upper limit.

According to the present invention, after the web page is displayed, for example, in a case where the web page is left by the user as it is, it is possible to prevent the display time from being unnecessarily counted at the time for which the web page is left as it is.

The invention according to claim 8 is the information processing apparatus according to claim 7,

wherein the count upper limit is set based on a volume of other content information displayed within the display area together with the content information.

According to the present invention, it is possible to increase the accuracy as the time estimated as being browsed by the user.

The invention according to claim 9 is the information processing apparatus according to claim 5,

wherein the third integrating means integrates the display time counted by the counting means for each user of terminal devices including the displaying means, and

the counting means stops counting the display time of the content information displayed within the display area of the terminal device of the user, for which the display time integrated by the third integrating means for each user exceeds a preset count upper limit.

According to the present invention, it is possible to prevent the time corresponding the set time from being consumed in large amounts by some users and to allow more users to browse the content information, for example, for more than a desired time.

The invention according to claim 10 is the information processing apparatus according to any one of claims 1 to 9,

wherein the counting means stops counting the display time according to a change of the display area, in which the content information is displayed, from an active state to an inactive state.

According to the present invention, since the web page being in the inactive state is considered as not being browsed by the user, it is possible to prevent the display time from being unnecessarily counted.

The invention according to claim 11 is the information processing apparatus according to any one of claims 1 to 10,

wherein the counting means counts the display time when a speed of a scroll of display content including the content information displayed in the display area is equal to or less than a predetermined speed.

According to the present invention, since it is considered that the web page is not browsed slowly when the speed of the scroll is faster than a predetermined time, it is possible to prevent the display time from being unnecessarily counted.

The invention according to claim 12 is an information processing method, which is executed by a computer, the information processing method comprising:

a step of counting a display time for which content information preset as a count target of a display time is displayed within a display area of a displaying means; and

a step of continuously or intermittently displaying the content information within the display area until the counted display time exceeds a set time preset to the content information.

The invention according to claim 13 is an information processing program, which causes a computer to function as:

a counting means that counts a display time for which content information preset as a count target of a display time is displayed within a display area of a displaying means; and

a display controlling means that continuously or intermittently displays the content information within the display area until the display time counted by the counting means exceeds a set time preset to the content information.

The invention according to claim 14 is a recording medium having stored therein an information processing program, which causes a computer to function as:

a counting means that counts a display time for which content information preset as a count target of a display time is displayed within a display area of a displaying means; and

a display controlling means that continuously or intermittently displays the content information within the display area until the display time counted by the counting means exceeds a set time preset to the content information.

### Advantageous Effect of the Invention

According to the present invention, control can be performed such that the display time of the content information with respect to the user exceeds the time desired by the provider of the content information or approaches the corresponding time as close as possible.

### BRIEF DESCRIPTION OF DRAWINGS

FIG. 1 is a diagram illustrating an example of a schematic configuration of an information providing system S according to the present embodiment.

FIG. 2 is a block diagram illustrating an example of a schematic configuration of an information providing server SA according to the present invention.

FIGS. 3A and 3B are diagrams illustrating examples of contents registered in a variety of databases.

FIG. 4 is a block diagram illustrating an example of a schematic configuration of a user terminal Tn according to the present embodiment.

FIGS. 5A and 5B are flowcharts illustrating information providing processing in a system control unit 4 of the information providing server SA according to a first embodiment.

FIG. 6 is a flowchart illustrating web page displaying processing in a system control unit 27 of a user terminal T1 according to a first embodiment.

FIGS. 7A to 7C are diagrams illustrating examples of web pages displayed on a window screen.

FIGS. 8A and 8B are flowcharts illustrating information providing processing in the system control unit 4 of the information providing server SA according to a second embodiment.

FIG. 9 is a flowchart illustrating web page displaying processing in the system control unit 27 of the user terminal T1 according to a third embodiment.

FIG. 10 is a flowchart illustrating web page displaying processing according to a fourth embodiment.

### MODE FOR CARRYING OUT THE INVENTION

Hereinafter, embodiments of the present invention will be described with reference to the drawings. Also, embodiments described below are embodiments in a case where the present invention is applied to an information providing system.

[1. Schematic Configuration and Function of Information Providing System]

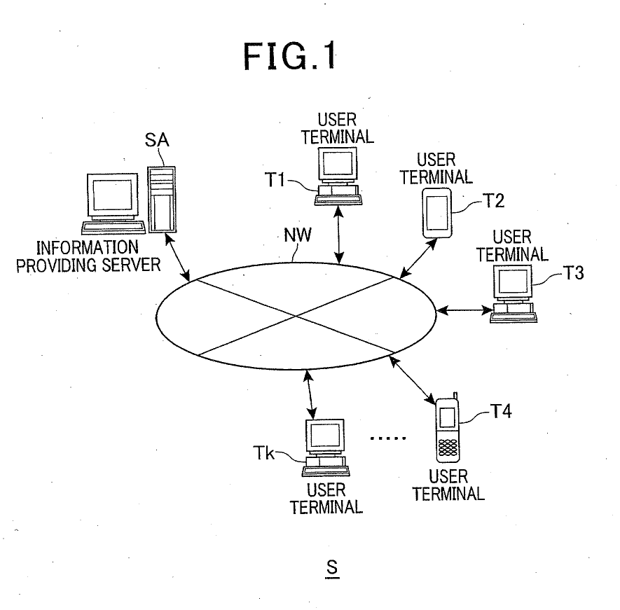

First, a schematic configuration and function of an information providing system S according to an embodiment of the present invention will be described with reference to FIG. 1.

FIG. 1 is a diagram illustrating an example of a schematic configuration of the information providing system S according to the present embodiment.

As illustrated in FIG. 1, the information providing system S includes a plurality of user terminals (example of a terminal device) Tn (n=1, 2, 3 . . . k) and an information providing server (example of an information processing apparatus) SA. The user terminals Tn and the information providing server SA are, respectively, connected to a network NW. The network NW is constructed by, for example, Internet, a dedicated communication line (e.g., Community Antenna Television (CATV) line), a mobile communication network (including a base station and the like), a gateway, or the like.

The information providing server SA is a server (e.g., a web server, a database server, or the like) that is installed for operating, for example, a shopping site, a travel reservation site, an accommodation reservation site, or the like.

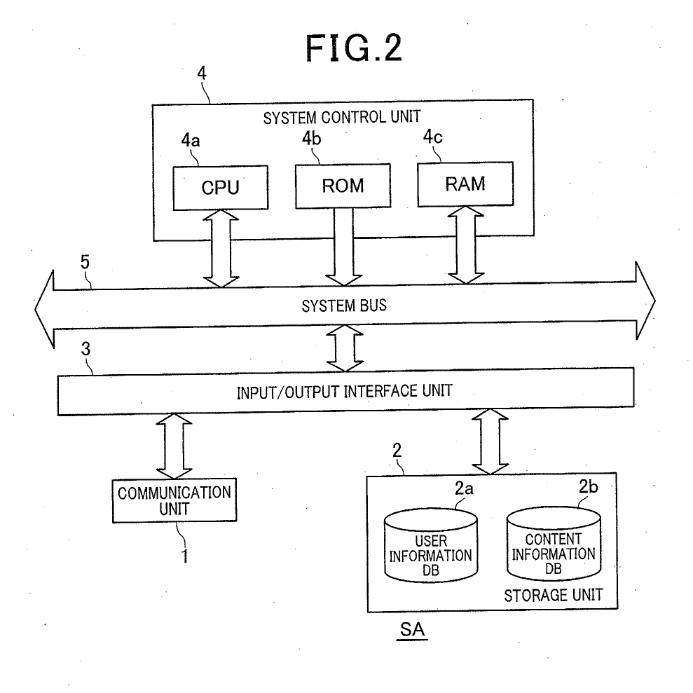

FIG. 2 is a block diagram illustrating an example of a schematic configuration of the information providing server SA according to the present embodiment. As illustrated in FIG. 2, the information providing server SA includes a communication unit 1, a storage unit 2, an input/output interface unit 3, and a system control unit 4. The system control unit 4 and the input/output interface unit 3 are connected through a system bus 5.

The communication unit 1 is configured to access the network NW and control a communication state with the user terminal Tn.

The storage unit 2 is configured by, for example, a hard disk drive or the like, and stores various programs, such as an operating system and a server program (including all or part of an information processing program of the present invention). Also, the server program, for example, may be distributed from a predetermined server or the like through the network NW, or may be provided in a state of being recorded on a recording medium, such as a compact disc (CD), a digital versatile disc (DVD), or the like.

Also, the storage unit 2 stores a structured document (e.g., hyper text markup language (HTML) document or XHTML document) file constituting a web page for displaying a variety of content information, an image file, and the like. Each piece of the content information arranged on the web page is constituted by, for example, at least one of a text, a still picture, and a moving picture.

Also, examples of the content information may include content information including information of products provided as commercial transaction objects by product sellers, and advertisement content information including information of advertisements provided as advertisement objects by advertisers. The advertisement content information is arranged (posted) on the web page, for example, when the advertiser pays an advertising fee to a site operator. In the present embodiment, by the agreement between the advertiser and the site operator, it is guaranteed that a display time (in other words, exposure time) of the content information exceeds a desired time, or approaches the desired time as close as possible. The site operator can preset content information, which is an object guaranteeing such a display, as a target for counting of the display time. Also, the site operator can preset content information, which he or she wants to preferentially display, as a count target of the display time. For example, the content information set as the count target of the display time is configured such that a display time is counted, which is displayed within a display area of a display unit (example of a displaying means) of the user terminal Tn. The content information set as the count target of the display time will be hereinafter referred to as “content information of time count target”. Also, for example, in the structured document constituting the web page, the content information is described as an element organized by div tag (<div> . . . </div>) with respect to each piece of content information.

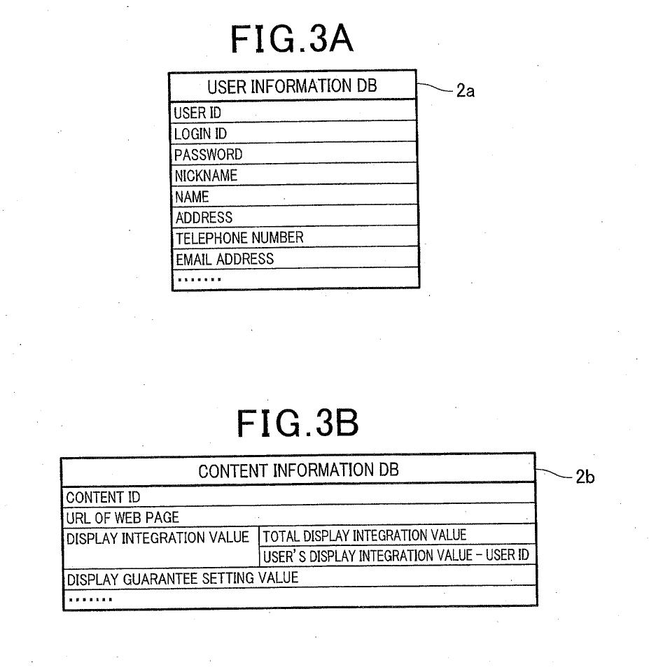

Also, a user information database (DB) 2a, a content information database (DB) 2b, and the like are constructed in the storage unit 2. FIGS. 3A and 3B are diagrams illustrating examples of contents (items) registered in a variety of databases.

As illustrated in FIG. 3A, user ID, login ID, password, nickname, name, address, telephone number, email address, and the like of each user who is registered as a member, are registered in the user information database 2a in association with one another. The user ID is identification information for identifying the user. The login ID and the password are authentication information used for login processing (user authentication processing).

Content ID, uniform resource locator (URL) of the web page, display integration value, and display guarantee setting value, and the like of each content information of the time count target are registered in the content information database 2b in association with one another. The content ID is content identification information for identifying the content information. In the structured document constituting the web page, the content ID is described as, for example, an id attribute within the div tags (<div> . . . </div>) defining the content information. The URL of the web page is a URL of a web page on which the content information of the time count target is arranged. The display integration value is a value obtained by integrating the display time counted when the content information of the time count target is displayed within the display area of the display unit. Also, since the web page, on which the content information of the time count target is arranged, is displayed on the display units of the plurality of user terminals Tn, the display integration value is a value integrated while being categorized by the plurality of users (hereinafter, referred to as a “total display integration value”). For example, the total display integration value is a value obtained by integrating each display time counted for each of the users of the user terminals Tn. Also, it may be configured such that the display time counted for each of the users is integrated (that is, the counted display time is integrated in association with the user ID) and is registered in the content information database 2b as the user's display integration value in association with the user ID with respect to each of the users. The display guarantee setting value is a setting time that is preset in association with (in relation to) the content information of the time count target. The display guarantee setting value, for example, is agreed between the site operator and the advertiser. Also, the content information of the time count target can be specified (identified) by the web browser from the structured document constituting the web page. For example, a number system for the content ID of the content information of the time count target and a number system for the content ID of content information of no time count target are differently set. Alternatively, it may be configured such that a value, which characterizes being the corresponding content information, is defined in div tags defining the content information of no time count target.

The input/output interface unit 3 is configured to perform interface processing among the communication unit 1, the storage unit 2, and the system control unit 4.

The system control unit 4 is configured by a central processing unit (CPU) 4a, a read only memory (ROM) 4b, a random access memory (RAM) 4c, and the like. The system control unit 4 as a computer is configured to execute a server program to perform a variety of processing in response to a request from the user terminal Tn. For example, in response to a page request from the user terminal Tn, the system control unit 4 transmits the structured document file or the like of the web page to the user terminal Tn through the network NW, and displays the web page. Independently or together with a system control unit 27 of the user terminal Tn, the system control unit 4 functions as a counting means, a display controlling means, an acquiring means, a second integrating means, and a third integrating means of the present invention, and performs the following processing.

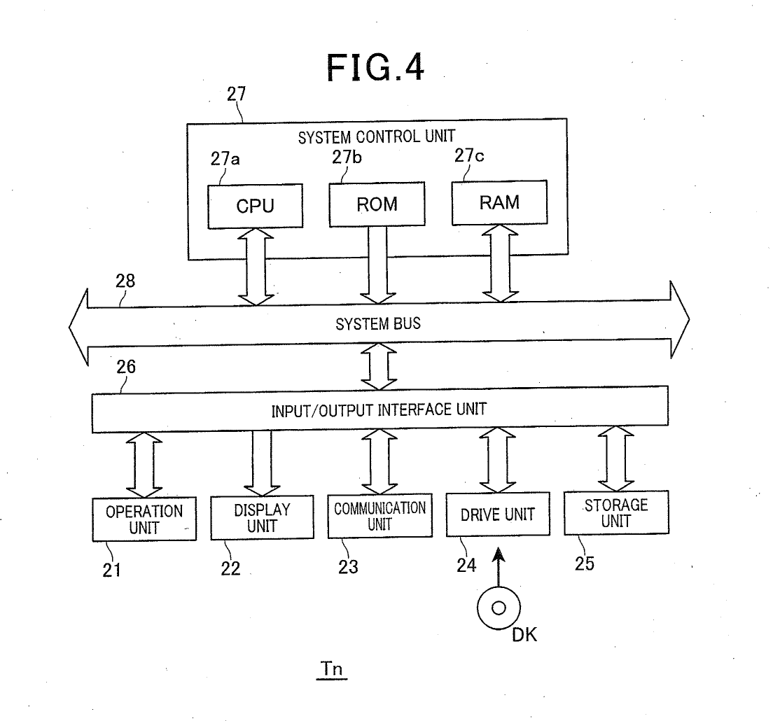

Next, FIG. 4 is a block diagram illustrating an example of a schematic configuration of the user terminal Tn according to the present embodiment. As illustrated in FIG. 4, the user terminal Tn includes an operation unit 21, a display unit 22, a communication unit 23, a drive unit 24, a storage unit 25, an input/output interface unit 26, and a system control unit 27. The system control unit 27 and the input/output interface unit 26 are connected through a system bus 28. For example, a personal computer (PC), a mobile phone, a personal digital assistant (PDA), a portable terminal (smartphone) converged with a mobile phone and a PDA, or a portable game machine can be applied as an example of the user terminal Tn.

Examples of the operation unit 21 may include a keyboard, a mouse, a remote controller, and a touch panel interface. When the operation unit 21 is operated by a user, an operation signal corresponding to the operation is output to the system control unit 27.

The display unit 22 includes a display for displaying a variety of information. The communication unit 23 accesses the network NW and controls a communication state with the information providing server SA or the like. The drive unit 24 reads data or the like from a disk DK (recording medium), such as a compact disc (CD) and a digital versatile disc (DVD), and records data or the like on the disk DK. The storage unit 25 is configured by, for example, a hard disk drive or the like, and stores an operating system (O/S), a web browser program, and an application program (including all or part of the information processing program of the present invention).

The system control unit 27 is configured by a CPU 27a, a ROM 27b, a RAM 27c, and the like. The system control unit 27 as a computer is configured to start the web browser by executing the web browser program, and perform a variety of processing according to the operation of the operation unit 21 by the user (hereinafter, referred to as “user operation”). For example, when making a page request to the information providing server SA and receiving the structured document file or the like of the web page from the information providing server SA, the system control unit 27 displays the web page within the display area of the window screen on the display unit 22. Independently or together with the system control unit 4 of the information providing server SA, the system control unit 27 functions as a counting means, a display controlling means, an acquiring means, and a first integrating means of the present invention, and performs the following processing.

Also, at least one of the system control unit 27 and the system control unit 4 functioning as the counting means and the display controlling means in the present invention is configured to count the display time for which the content information of the time count target is displayed within the display area, and perform control such that the corresponding content information is continuously or intermittently displayed within the display area until the counted display time exceeds the display guarantee setting value set to the content information of the time count target. Herein, the intermittent displaying corresponds to, for example, a case where the content information of the time count target is shifted to the outside of the display area once by, for example, a scroll (that is, disappeared from the display area once), and then, is displayed again within the display area. Also, the intermittent displaying corresponds to, for example, a case where the window screen (window screen of the web browser) having the display area where the content information of the time count target is displayed is closed by, for example, a session termination, and then, the corresponding content information is displayed in a display area of a window screen newly opened by a next session initiation (that is, a case of crossing the session). Also, the continuous or intermittent displaying of the content information within the display area will be referred to as “continuous displaying”. The continuous displaying is set to ON or OFF in the structured document constituting the web page, including the content information of the time count target, by the information providing server SA.

[2. Operation of Information Providing System]

Next, the operation of the information providing system according to the present embodiment will be described separately in first to third embodiments.

### First Embodiment

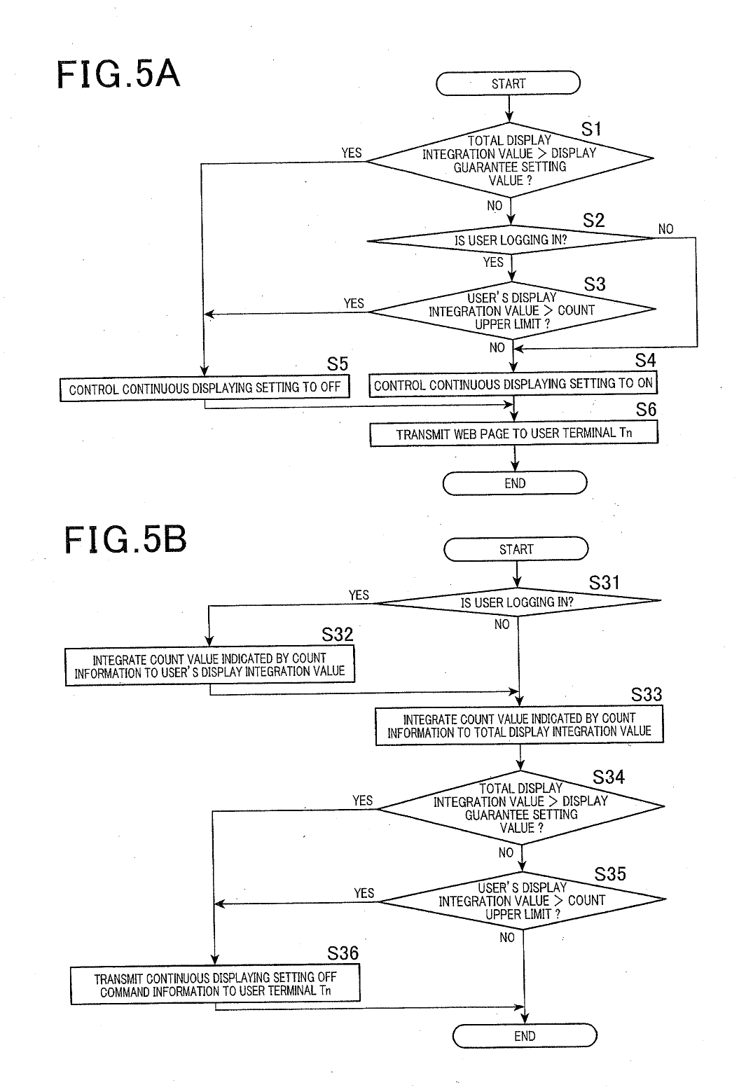

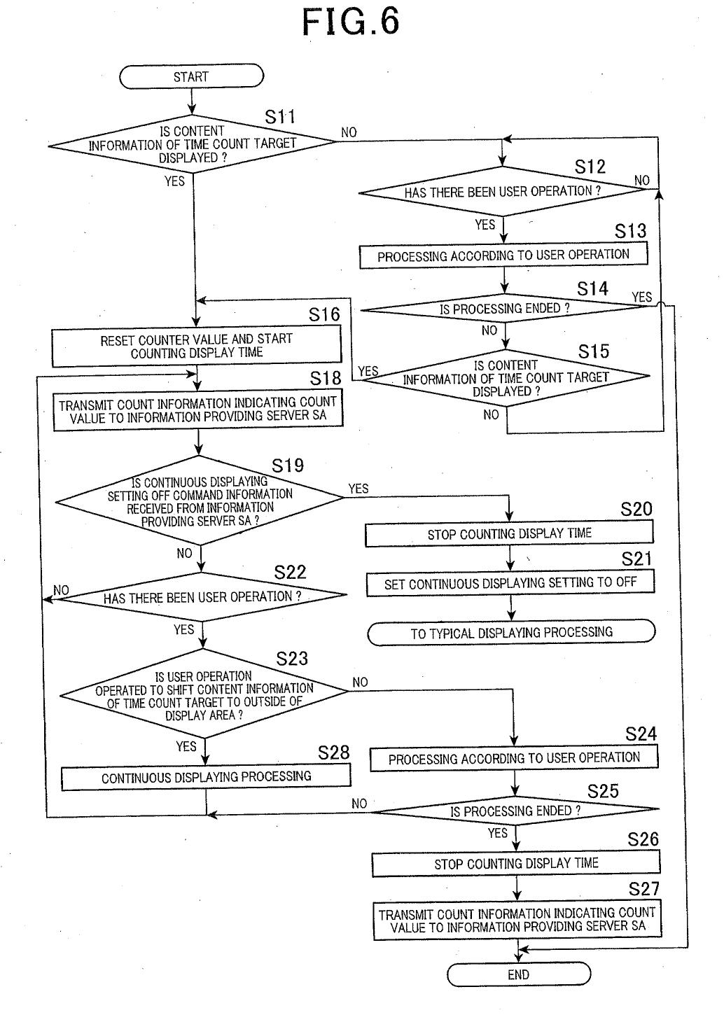

First, content information displaying processing according to a first embodiment will be described with reference to FIGS. 5A and 5B, FIG. 6, and the like. FIGS. 5A and 5B are flowcharts illustrating information providing processing in the system control unit 4 of the information providing server SA according to the first embodiment. FIG. 6 is a flowchart illustrating web page displaying processing in the system control unit 27 of the user terminal T1 according to the first embodiment.

Also, the first embodiment is an operation to continuously display the content information until the total display integration value exceeds the display guarantee setting value set to all the users, the total display integration value being obtained by integrating the count values of the display time of the content information of the time count target while being categorized by the plurality of users.

First, the processing of FIG. 5A is a page request (HTTP request) transmitted by the web browser from the user terminal T1 in which the session is established with the information providing server SA. The processing of FIG. 5A is started when there is a request for the web page on which the content information of the time count target is arranged, and the content ID of the content information of the time count target is specified. At this time, in a case where a plurality of pieces of content information of the time count target is arranged on the corresponding web page, a content ID of each piece of the content information is specified, and processing illustrated in steps S1 to S5 of FIG. 5A is performed with respect to each piece of the content information of the time count target. Also, both of a case where the user of the user terminal T1 has logged in by login processing of the information providing server SA before receiving the page request and a case where having not logged in are considered.

When the processing illustrated in FIG. 5A is started, the system control unit 4 acquires the total display integration value, which is associated with the specified content ID, and the display guarantee setting value, which is set to all the users, from the content information database 2b, and determines whether the acquired total display integration value (that is, the total count value of the display time of the content information of the time count target) exceeds the acquired display guarantee setting value (step S1). When it is determined that the total display integration value exceeds the display guarantee setting value (YES in the step S1), the system control unit 4 proceeds to step S5. On the other hand, when it is determined that the total display integration value does not exceed the display guarantee setting value (NO in the step S1), the system control unit 4 proceeds to step S2.

In step S2, the system control unit 4 determines whether the user of the user terminal T1 is logging in. When it is determined that the user of the user terminal T1 is logging in (the user ID of the corresponding user is specified) (YES in the step S2), the system control unit 4 proceeds to step S3. On the other hand, when it is determined that the user of the user terminal T1 is not logging in (NO in the step S2), the system control unit 4 proceeds to step S4.

In step S3, the system control unit 4 acquires the user's display integration value from the content information database 2b, the user's display integration value being associated with the specified content ID and associated with the user ID of the user of the user terminal T1, and determines whether the acquired user's display integration value exceeds a count upper limit that is preset (e.g., set as default in the structured document constituting the requested web page). Herein, the count upper limit means an upper limit of a display integration value per user, in which the integrating is permitted to the total display integration value. For example, in the case of browsing the content information for more than 100 hours (display guarantee setting value) for a plurality of persons, 30 minutes per user is the count upper limit of the display time of the corresponding content information. Therefore, it is possible to prevent the time corresponding to the display guarantee setting value from being consumed in large amounts by some users and to allow more users to browse the content information, for example, for more than a desired time. The count upper limit, for example, is individually set for each piece of the content information of the time count target.

Then, when it is determined that the use's display integration value does not exceed the count upper limit (NO in the step S3), the system control unit 4 proceeds to step S4. On the other hand, when it is determined that the use's display integration value exceeds the count upper limit (YES in the step S3), the system control unit 4 proceeds to step S5.

In step S4, the system control unit 4 performs control such that the continuous displaying setting defined in the structured document constituting the requested web page becomes ON.

On the other hand, in step S5, the system control unit 4 performs control such that the continuous displaying setting defined in the structured document constituting the requested web page becomes OFF. That is, when the total display integration value exceeds the display guarantee setting value, or when the user's display integration value of the user terminal T1 exceeds the count upper limit, the count of the display time of the content information displayed in the display area of the user terminal T1 of the corresponding user is stopped.

Also, the continuous displaying setting may be configured such that the setting is set to OFF (or ON) as default in the structured document constituting the requested web page and is changed to OFF (or ON) according to the determination result of the step S1 or S3. Also, when a plurality of pieces of content information of the time count target is arranged in the web page, the continuous displaying setting associated with each piece of the content information becomes ON or OFF.

Then, the system control unit 4 transmits the structured document file or the like of the web page, in which the setting of the count upper limit and the continuous displaying setting are done, to the user terminal T1, which has transmitted the request, as a response (step S6), and ends the corresponding processing.

The system control unit 27 of the user terminal T1 receives the structured document file or the like of the web page transmitted from the information providing server SA. When the continuous displaying setting defined in the structured document file is ON, the system control unit 27 of the user terminal T1 starts processing illustrated in FIG. 6 and displays the corresponding web page on the window screen. Also, in a case where a plurality of pieces of content information of the time count target is arranged in the web page, the processing illustrated in FIG. 6 is started when the continuous displaying setting associated with one piece of the content information among the continuous displaying settings associated with the respective pieces of the content information is ON. On the other hand, when all the continuous displaying settings are OFF, typical displaying processing is performed, and a description thereof will be omitted. Also, in the processing illustrated in FIG. 6, which is to be described below, a case where one piece of the content information of the time count target is arranged on the web page will be described as an example for convenience of explanation.

When the processing illustrated in FIG. 6 is started, the system control unit 27 determines whether the content information of the time count target is displayed within the display area of the window screen (step S11). This determination is performed by determining whether id defined by the div tags defining the content information displayed within the display area of the window screen has a number system of the content ID of the content information of the time count target. Alternatively, the determination is performed by determining whether a value, which characterizes being the time count target, is defined in the div tags defining the content information. Then, when it is determined that the content information of the time count target is not displayed within the display area of the window screen (NO in the step S11), the system control unit 27 proceeds to step S12.

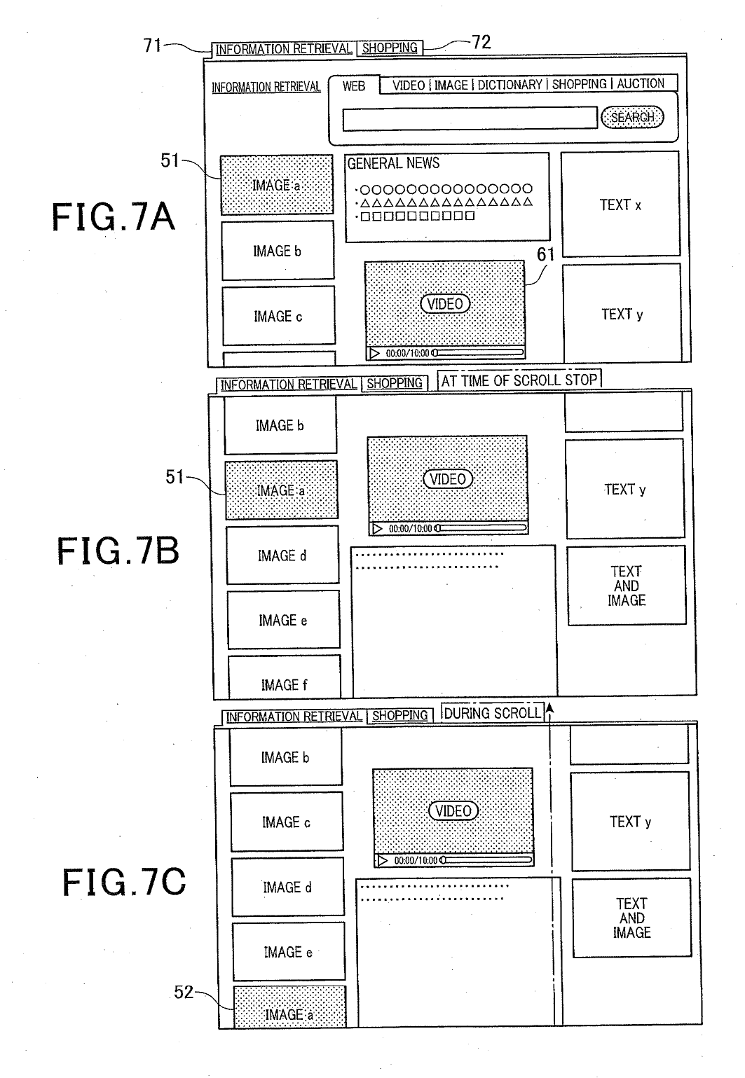

FIG. 7A is a diagram illustrating a display example of the web page displayed on the window screen. In the example illustrated in FIG. 7A, content information of images a to c, content information of texts x and y, and video content information 61 are arranged on the web page. Among them, the content information 51 of the image a is the content information of the time count target.

On the other hand, when it is determined that the content information of the time count target is displayed within the display area of the window screen (e.g., the content information of the time count target is included among a plurality of displayed content information) (YES in the step S11), the system control unit 27 specifies the corresponding content information (e.g., specifies the corresponding content information defined by the div tags (data surrounded by <div> and </div>)), and proceeds to step S16.

In step S12, the system control unit 27 determines whether there has been a user operation. Then, when there has been the user operation (YES in the step S12), the system control unit 27 performs processing according to the user operation (step S13). When the user operation is, for example, a scroll operation to scroll display content including the content information displayed in the display area of the window screen, the scrolling processing of scrolling the display content (in other words, scrolling the web page) is performed according to the scroll operation. Examples of the user operation other than the scroll operation may include a sort operation and a page transition operation (screen transition operation). Herein, the page transition operation is an operation to transition a page of the display content including the content information, which is arranged on the web page displayed on the window screen, to a page including other display content. As a specific example of the page transition operation, a user may use a mouse to click an image or a character string with a link displayed on the window screen. Also, the sort operation is an operation to update the arrangement of the content information in a partial display area of the web page displayed on the window screen (e.g., changes a sorting order of a plurality of pieces of content information displayed in a list). By using, for example, Ajax, the sort processing according to the sort operation is performed without refreshing the entire web page (reloading from the information providing server SA by the user terminal T1). As a specific example of the sort operation, a user may use a mouse to click a button or the like displayed on the web page (e.g., a portion linked with “low price”).

Then, the system control unit 27 determines whether to end the web page displaying processing as a result of the user operation (step S14). For example, when a page ending operation has been performed by a user (e.g., a “close” button of the web browser has been clicked by a mouse), the system control unit 27 determines to end the web page displaying processing. Then, when it is determined to end the web page displaying processing (YES in step S14), the web page displaying processing is ended. On the other hand, when it is determined not to end the web page displaying processing (NO in the step S14), the system control unit 27 proceeds to step S15.

In step S15, the system control unit 27 determines whether the content information of the time count target is displayed within the display area of the window screen. Then, when it is determined that the content information of the time count target is not displayed within the display area of the window screen (NO in the step S15), the system control unit 27 returns to the step S12. On the other hand, when it is determined that the content information of the time count target is displayed within the display area of the window screen (YES in the step S15), the system control unit 27 specifies the corresponding content information, and proceeds to the step S16.

In step S16, the system control unit 27 resets (that is, setting to “0”) the count value of the content information of the time count target (e.g., storing in a predetermined storage area of the RAM 27c), and starts the count of the display time of the content information of the time count target. Therefore, the count value of the content information of the time count target is incremented with the passage of time (the count value corresponds to the elapsed time).

Then, the system control unit 27 transmits the count information, which indicates the count value of the content information of the time count target, and the content ID of the content information to the information providing server SA (step S18), and resets the count value to resume the count of the display time of the content information. Then, the system control unit 27 proceeds to step S19. In this way, for example, the count information indicating the count value counted after the previous transmission at constant periods is transmitted to the information providing server SA. Also, for example, it may be configured such that, when the user of the user terminal T1 has logged in, the user ID of the user is added to the count information.

When receiving the count information and the content ID transmitted from the user terminal T1, the system control unit 4 of the information providing server SA starts processing illustrated in FIG. 5B, and determines whether the user of the user terminal T1 is logging in (step S31). Then, when it is determined that the user of the user terminal T1 is logging in (YES in the step S31), the system control unit 4 proceeds to step S32. On the other hand, when it is determined that the user of the user terminal T1 is not logging in (NO in the step S31), the system control unit 4 proceeds to step S33.

In step S32, the system control unit 4 integrates (updates and registers in the content information database 2b) the count value, which is indicated by the received count information, to the user's display integration value, which is associated with the received content ID and associated with the user ID of the user of the user terminal T1, and proceeds to step S33. It can be said that this processing is processing in which the system control unit 4 counts the display time of the content information associated with the content ID.

In step S33, the system control unit 4 integrates (updates and registers in the content information database 2b) the count value, which is indicated by the received count information, to the total display integration value, which is associated with the received content ID, and proceeds to step S34.

In step S34, the system control unit 4 determines whether the total display integration value, to which the count value is integrated in the step S33, exceeds the display guarantee setting value associated with the received content ID. Then, when it is determined that the total display integration value exceeds the display guarantee setting value (YES in the step S34), the system control unit 4 proceeds to step S36. On the other hand, when it is determined that the total display integration value does not exceed the display guarantee setting value (NO in the step S34), the system control unit 4 proceeds to step S35.

In step S35, the system control unit 4 determines whether the user's display integration value, to which the count value is integrated in the step S32, exceeds the count upper limit of the content information per person which is associated with the received content ID. Then, when it is determined that the use's display integration value does not exceed the count upper limit (NO in the step S35), the system control unit 4 ends the corresponding processing. On the other hand, when it is determined that the use's display integration value exceeds the count upper limit (YES in the step S35), the system control unit 4 proceeds to step S36.

In step S36, the system control unit 4 transmits continuous displaying setting OFF command information and the received content ID to the user terminal T1 having transmitted the count information, and ends the corresponding processing. The continuous displaying setting OFF command information refers to a command that turns OFF the continuous displaying setting of the content information associated with the received content ID. Also, when the plurality of user terminals Tn accesses the information providing server SA at the same time, the system control unit 4 also receives count information from the user terminals other than the user terminal T1, for example, the user terminal T2. At this time, for example, in a case where the total display integration value already exceeds the display guarantee setting value due to the integration of the count value from the user terminal T1, it may be configured such that the continuous displaying setting OFF command information is transmitted to the user terminal T2, without performing the processing illustrated in FIG. 5B.

Returning to the processing illustrated in FIG. 6, in step S19, the system control unit 27 determines whether the continuous displaying setting OFF command information and the content ID have been received from the information providing server SA. Then, when it is determined that the continuous displaying setting OFF command information has been received from the information providing server SA (YES in the step S19), the system control unit 27 stops counting the display time of the content information associated with the received content ID (step S20) and turns OFF the continuous displaying setting of the content information (step S21). In this way, the processing is shifted to the typical displaying processing. On the other hand, when it is determined that the continuous displaying setting OFF command information has not been received from the information providing server SA (NO in the step S19), the system control unit 27 proceeds to step S22.

In step S22, the system control unit 27 determines whether there has been a user operation. Then, when there has not been the user operation (NO in the step S22), the system control unit 27 returns to the step S18 and repeats the above-described processing. On the other hand, when there has been the user operation (YES in the step S22), the system control unit 27 determines whether the corresponding user operation is a user operation to shift the content information of the time count target to the outside of the display area in a state in which the displaying of the web page is maintained (that is, without page end or page transition) (step S23). Examples of the user operation to shift the content information to the outside of the display area include a scroll operation and a sort operation.

Then, when it is determined that the user operation is not the user operation to shift the content information of the time count target to the outside of the display area (NO in the step S23), the system control unit 27 proceeds to step S24. On the other hand, when it is determined that the user operation is the user operation to shift the content information of the time count target to the outside of the display area (YES in the step S23), the system control unit 27 proceeds to step S28.

In step S24, the system control unit 27 performs processing according to the user operation. Then, the system control unit 27 determines whether to end the web page displaying processing as a result of the user operation (step S25). Then, when it is determined to end the web page displaying processing (YES in the step S25), the system control unit 27 stops counting the display time of the content information (step S26), and transmits the count information, which indicates the count value of the content information, and the content ID of the content information to the information providing server SA (step S27). Therefore, the information providing server SA performs the processing illustrated in FIG. 5A in the same manner as described above. On the other hand, when it is determined not to end the web page displaying processing (NO in the step S25), the system control unit 27 returns to step S18.

Then, in step S28, the system control unit 27 performs the continuous displaying processing of the content information of the time count target. Also, the continuous displaying processing, for example, is defined by a script described in the structured document constituting the web page (e.g., by JavaScript (registered trademark)). In the continuous displaying processing, when the user operation is performed to shift the content information of the time count target to the outside of the display area, the continuous or intermittent displaying of the content information within the corresponding display area is continued.

For example, when the content information of the time count target is shifted to the outside of the display area by the scroll (that is, the content information displayed on the window screen at the time of starting the scroll is not displayed with the progress of the scroll), the system control unit 27 in the continuous displaying processing after scroll stop, continues to display the content information of the time count target after the scroll stop by replacing the content information of the time count target, which is shifted to the outside of the display area, and other content information (e.g., both of content information defined by the div tag (data surrounded by <div> and </div>)), which is displayed within the display area after the scroll stop (after the scroll operation). Also, in this case, during the scroll of the web page (during the scroll operation by the user), the continuous displaying processing of the content information of the time count target is not performed. FIG. 7B is a diagram illustrating a display example at the time of the scroll stop of the web page scrolled from the display state illustrated in FIG. 7A. Due to the continuous displaying processing, as illustrated in FIG. 7B, the content information 51 of the time count target is replaced with the content information of the image C. Also, when a plurality of candidates of other content information replacing the content information 51 of the time count target is displayed within the display area, the content information having, for example, the lowest display priority degree (or display priority order) among these candidates is determined as a replacement target. In this case, the display priority is set to each piece of the content information. The display priority degree refers to a priority degree for displaying the content information in the display area. Also, the display priority degree is represented by, for example, a number. As the number is smaller (or larger), the display priority degree becomes higher. Alternatively, it may be configured such that the display priority order instead of the display priority degree is set to each piece of the content information. The display priority order refers to a priority order for displaying the content information in the display area. Also, the display priority degree or the display priority order, for example, are registered in the content information database 2b in association with each content ID, and are described in the structured document of the web page.

Also, in the continuous displaying processing, it may be configured such that the continuous displaying processing of the content information of the time count target is performed during the scroll of the web page (during the scroll operation by the user). That is, in this case, the system control unit 27 continues to display the content information of the time count target even during the scroll by replacing the content information of the time count target and the content information displayed within the display area during the scroll, at predetermined intervals, during the scroll of the web page (during the scroll operation by the user). Herein, “at predetermined intervals” may be, for example, whenever the content information of the time count target is shifted to the outside of the display area.

Also, as another example of the continuous displaying processing, the system control unit 27 may be configured to insert the content information of the time count target before or after other content information. In this case, for example, in the structured document of the web page, an empty div tag (e.g., empty between <div> and </div>) is previously described between div tags defining each piece of the content information (data surrounded by <div> and </div>). In the continuous displaying processing, the system control unit 27 copies the content information of the time count target. For example, the content information is copied from the structured document constituting the web page on which the content information defined by the div tag (data surrounded by <div> and </div>) is displayed. When the content information of the time count target is shifted to the outside of the display area by the scroll, the system control unit 27 inserts the empty tag before or after other content information by replacing it with the div tag defining the copied content information (data surrounded by <div> and </div>). Also, this replacement may be configured to be performed during the scroll, or may be configured to be performed after the scroll stop. FIG. 7C is a diagram illustrating a display example of the web page during the scroll from the display state illustrated in FIG. 7A. Due to the continuous displaying processing, as illustrated in FIG. 7C, the content information 52, which is a copy of the content information 51 of the time count target, is redisplayed by being inserted after the content information of the image e.

Also, it may be configured such that the copy of the content information of the time count target is inserted at an arbitrary location of a document object model (DOM) tree, which can be extracted from the structured document of the web page, by adding the div tag defining the copied content information (data surrounded by <div> and </div>) as an element (e.g., adding by appendChild( ) method defined by a script).

As described above, according to the first embodiment, the content information is continuously or intermittently displayed within the display area of the window screen until the total display integration value exceeds the display guarantee setting value (display guarantee setting value set to all the users), the total display integration value being obtained by integrating the count values of the display time of the content information of the time count target while being categorized by the plurality of users. Therefore, control can be performed such that the display time of the content information to the user exceeds a time desired by a provider of the content information, or comes close to the time as much as possible without giving discomfort to the user. In particular, in a case where the content information of the time count target is advertisement content information, the advertising effect appropriate for the advertising fee paid by the advertiser can be expected more than ever. Also, according to the first embodiment, it is possible to determine whether all the users have browsed the content information for more than the desired time. Also, according to the first embodiment, it is possible to accurately grasp the time for which the content information has been displayed to all the users.

### Second Embodiment

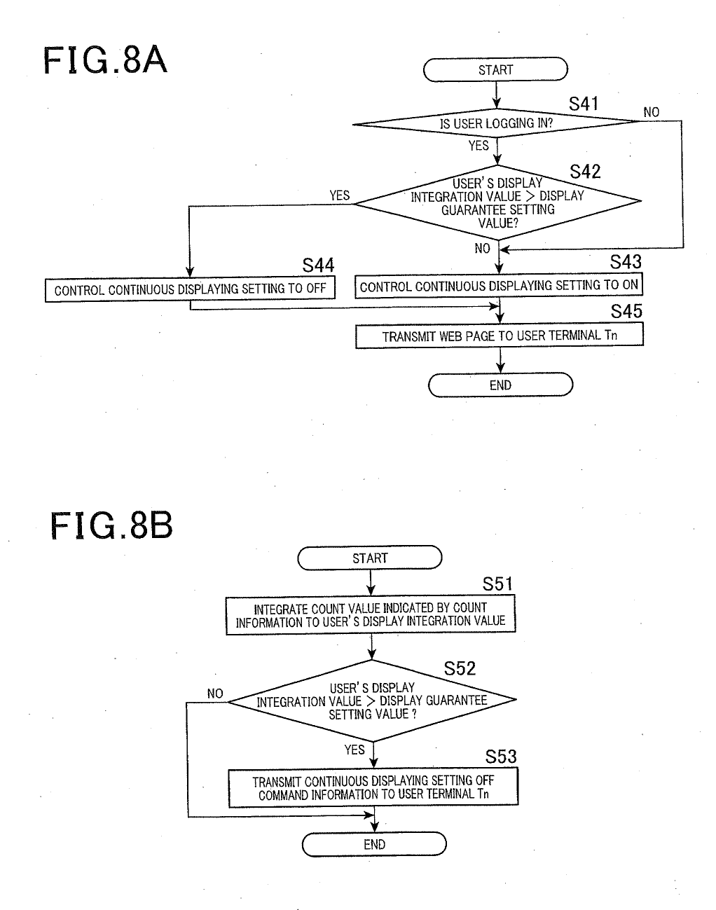

Next, content information displaying processing according to a second embodiment will be described with reference to FIGS. 8A and 8B, and the like. FIGS. 8A and 8B are flowcharts illustrating information providing processing in the system control unit 4 of the information providing server SA according to the second embodiment. Also, the processing illustrated in FIG. 6, which is applied to the first embodiment, is also applied to the second embodiment.

Also, the second embodiment is an operation to continuously display the content information until the user's display integration value exceeds the display guarantee setting value, the user's display integration value being obtained by integrating the count values of the display time of the content information of the time count target with respect to each user. In the second embodiment, it is unnecessary to register the total display integration value in the content information database 2b.

As in the processing illustrated in FIG. 5A, the processing illustrated in FIG. 8A is started when there is a request for the web page, on which the content information of the time count target is arranged, from the user terminal T1, in which the session is established with the information providing server SA. When the processing illustrated in FIG. 8A is started, the system control unit 4 determines whether the user of the user terminal T1 is logging in (step S41). Then, when it is determined that the user of the user terminal T1 is logging in (YES in the step S41), the system control unit 4 proceeds to step S42. On the other hand, when it is determined that the user of the user terminal T1 is not logging in (NO in the step S42), the system control unit 4 proceeds to step S45.

In step S42, the system control unit 4 acquires, from the content information database 2b, the display guarantee setting value associated with the specified content ID (display guarantee setting value set to each user) and the user's display integration value associated with the user ID of the user of the user terminal T1. Then, the system control unit 4 determines whether the acquired user's display integration value exceeds the acquired display guarantee setting value. The display guarantee setting value is compared with the display integration value of each user, but may be set to the same value with respect to each user, or may be set to different values with respect to each user. Also, it is preferable that the display guarantee setting value is set to more than a time minimally necessary when a user (single user) browses the content information (hereinafter, referred to as “display guarantee setting lower limit (minimum value)). Herein, the display guarantee setting lower limit is set based on, for example, a changed display time of the user. The “changed display time of the user” refers to, for example, “display time until the user clicks the content information after the displaying of the content information in the display area (e.g., it may be an average value, a minimum value, or a maximum value of the display time by the plurality of users)”. More preferably, the “changed display time of the user” refers to, for example, “display time until the user, who leads to a purchase of a product or the like through the content information by displaying the content information, clicks the content information from the displaying of the content information (e.g., it may be an average value, a minimum value, or a maximum value of the display time by the plurality of users)”. For example, the user's clicking of the displayed advertisement content information, without regard to the purchase or not, recognizes the effect of the corresponding advertisement. Therefore, by setting the display time until the clicking after the displaying of the corresponding content information as the display guarantee setting lower limit, the exposure to each user can be guaranteed with respect to the time recognizing the minimum advertisement effect. That is, the exposure time per user can be set to more than a display time capable of expecting the effect by the browsing (e.g., advertising effect). Also, the accuracy of the advertising effect can be increased by setting the “display time until the user, who leads to a purchase of a product or the like through the content information by displaying the content information, clicks the content information from the displaying of the content information” as the display guarantee setting lower limit.

Then, when it is determined that the use's display integration value does not exceed the display guarantee setting value (NO in the step S42), the system control unit 4 proceeds to step S43. On the other hand, when it is determined that the user's display integration value exceeds the display guarantee setting value (YES in the step S42), the system control unit 4 proceeds to step S44. Also, since the processing of steps S43 to S45 is the same as the processing of steps S4 to S6 of FIG. 5A, a description thereof will be omitted.

On the other hand, the user terminal T1, which receives the structured document file or the like of the web page transmitted from the information providing server SA, performs the processing illustrated in FIG. 6 when the user of the user terminal T1 is logging in. Also, when the user of the user terminal T1 is not logging in, typical displaying processing is performed. Then, when receiving the count information and the content ID transmitted from the user terminal T1 by, for example, the processing of the step S18 illustrated in FIG. 6, the system control unit 4 of the information providing server SA starts processing illustrated in FIG. 8B. In step S51 illustrated in FIG. 8B, the system control unit 4 integrates the count value, which is indicated by the received count information, to the user's display integration value, which is associated with the received content ID and associated with the user ID of the user of the user terminal T1. Then, the system control unit 4 determines whether the user's display integration value, to which the count value is integrated in the step S51, exceeds the display guarantee setting value associated with the received content ID. Then, when it is determined that the user's display integration value exceeds the display guarantee setting value (YES in the step S52), the system control unit 4 transmits continuous displaying setting OFF command information and the received content ID to the user terminal T1 having transmitted the count information (step S53), and ends the corresponding processing. On the other hand, when it is determined that the use's display integration value does not exceed the display guarantee setting value (NO in the step S52), the system control unit 4 ends the corresponding processing.

As described above, according to the second embodiment, the content information is configured to be continuously or intermittently displayed within the display area of the window screen until the user's display integration value exceeds the display guarantee setting value, the user's display integration value being obtained by integrating the count values of the display time of the content information of the time count target with respect to each of the users. Therefore, in addition to the effect of the first embodiment, control can be performed such that a time for which more different users browse exceeds a time desired by a provider of the content information, or comes close to the time as much as possible. Also, according to the second embodiment, since it is unnecessary to integrate the count values of the display time of the content information of the time count target while being categorized by the plurality of users, the processing load can be reduced as much.

### Third Embodiment

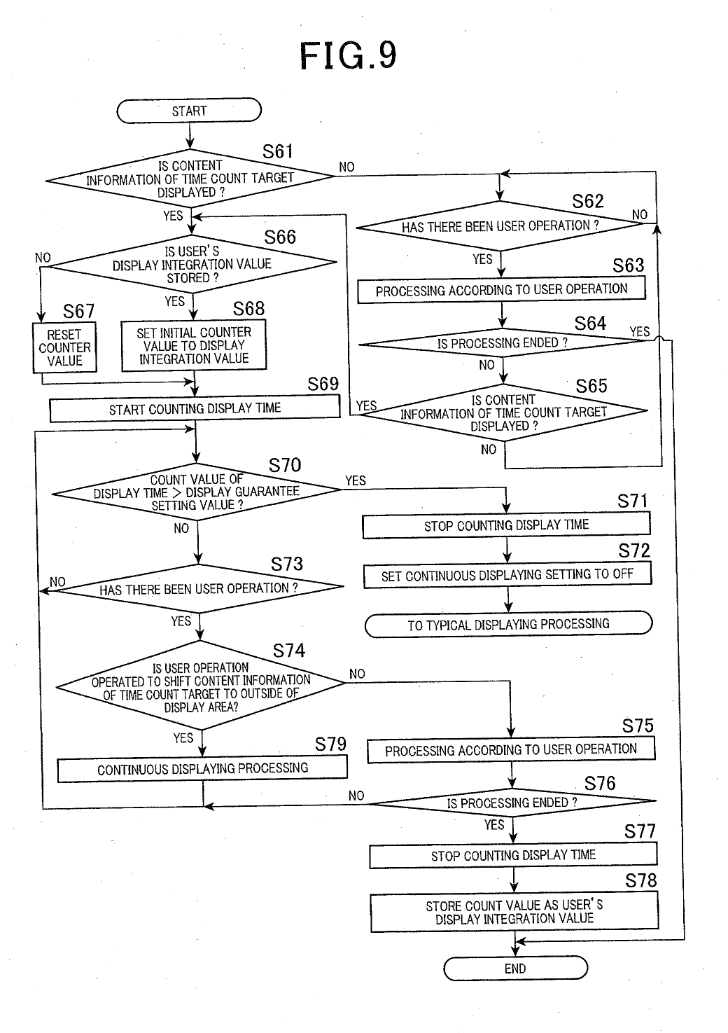

Next, content information displaying processing according to a third embodiment will be described with reference to FIG. 9 and the like. FIG. 9 is a flowchart illustrating web page displaying processing in the system control unit 27 of the user terminal T1 according to the third embodiment. The processing illustrated in FIG. 9 can be performed by installing the information processing program of the present invention on the user terminal T1 as, for example, plug-in software of the web browser (the user terminal T1 functions as the information processing apparatus of the present invention). Alternatively, the processing illustrated in FIG. 9 may be configured to be defined by a script described in the structured document constituting the web page.

Also, the third embodiment is an operation in a case where the user terminal T1 determines whether the count value of the display time of the content information exceeds the display guarantee setting value. In the third embodiment, it is unnecessary to register the user's display integration value and the total display integration value in the content information database 2b. However, in the structured document file of the web page transmitted from the information providing server SA to the user terminal T1, the continuous displaying setting is set to ON by default, and the display guarantee setting value is described in association with the content ID of the content information of the time count target arranged on the web page.

The processing illustrated in FIG. 9 is started when the user terminal T1, in which the session is established with the information providing server SA, receives the structured document file or the like of the web page transmitted from the information providing server SA, and the corresponding web page is displayed on the window screen. Also, since the processing of steps S61 to S65 is the same as the processing of steps S11 to S15 illustrated in FIG. 6, a description thereof will be omitted.

In step S16, by using the content ID or the like of the content information of the time count target, which is determined in the step S61 as being displayed, as a key, the system control unit 27 determines whether the display integration value of the user of the user terminal T1 is stored in, for example, a predetermined storage area of the storage unit 25, which can be referred to by the web browser, in association with the corresponding content ID or the like. Herein, for example, when the information processing program of the present invention is installed as the plug-in software of the web browser, the user's display integration value and the content ID are stored in a storage area secured at the time of the installation. Alternatively, it may be configured such that the user's display integration value and the content ID are issued (generated) by the information providing server SA, for example, when the previous displaying processing is ended, and are included in cookie information stored in a predetermined area of the storage unit 25 of the user terminal T1.

Then, when it is determined that the display integration value of the user of the user terminal T1 is not stored (NO in the step S66), the system control unit 27 resets the count value of the content information of the time count target (step S67), and starts counting the display time of the content information of the time count target (starts counting from zero) (step S69).

On the other hand, when it is determined that the display integration value of the user of the user terminal T1 is stored (YES in the step S66), the system control unit 27 sets an initial counter value to the display integration value (step S68), and starts counting the display time of the content information of the time count target (starts counting from the display integration value (e.g., 20 minutes)) (step S69). In this way, the display time to be counted is integrated over a plurality of sessions. Therefore, it is possible to continuously count the display time in different sessions, and as a result, it is possible to perform the determination of step S70 by using a fixed display guarantee setting value.

Then, the system control unit 27 determines whether the count value of the display time of the content information of the time count target exceeds the display guarantee setting value (step S70). Also, in the case of passing through the step S68, it is determined whether the count value integrated over the sessions exceeds the display guarantee setting value. Then, when it is determined that the count value of the display time exceeds the display guarantee setting value (YES in the step S70), the system control unit 27 proceeds to step S71. On the other hand, when it is determined that the count value of the display time does not exceed the display guarantee setting value (NO in the step S70), the system control unit 27 proceeds to step S73.

Also, since the processing of steps S71 to S77, and S79 is the same as the processing of steps S20 to S26, and S28 illustrated in FIG. 6, a description thereof will be omitted.

In step S78, the system control unit 27 stores the count value counted from the count start as the user's display integration value in a predetermined storage area of the storage unit 25 together with the content ID or the like of the content information of the time count target (the URL of the web page may be added). Herein, the system control unit 27 may be configured to transmit the user's display integration value and the content ID to the information providing server SA to issue cookie information including the user's display integration value and the content ID, and receive and store the corresponding cookie information from the information providing server SA.

As described above, according to the third embodiment, it is configured such that the determination as to whether the count value of the display time of the content information exceeds the display guarantee setting value is performed by the user terminal T1. Therefore, in addition to the effect of the first embodiment or the second embodiment, the processing load of the information processing server SA can be more reduced.

### Fourth Embodiment

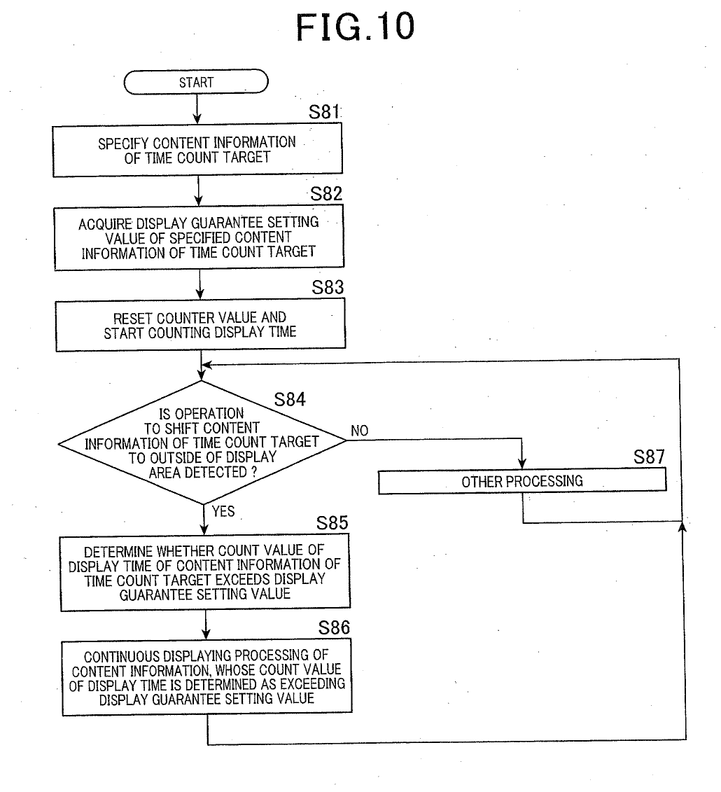

Next, content information displaying processing according to a fourth embodiment will be described with reference to FIG. 10. FIG. 10 is a flowchart illustrating web page displaying processing according to the fourth embodiment. The processing illustrated in FIG. 10 may be configured to be performed by one of the user terminal T1 and the information providing server SA.

Also, in the fourth embodiment, in a case where the user operation (e.g., scroll operation) to shift the content information of the time count target to the outside of the display area is detected in a state in which the displaying of the web page is maintained, it is determined whether the count value of the display time of the corresponding content information exceeds the display guarantee setting value. Also, in the fourth embodiment, it is assumed that a plurality of pieces of content information of the time count target is included in the web page (that is, a plurality of pieces of content information of the time count target is arranged on the same web page). The display priority order (or display priority degree) and the display guarantee setting value described above are set to each piece of the content information arranged on the web page in the above-described manner. For example, when there are three pieces A, B and C of the content information of the time count target arranged on the same web page, the priority order of the content information A is set to “ranking No. 1”, the priority order of the content information B is set to “ranking No. 2”, and the priority order of the content information C is set to “ranking No. 3”. In this case, the display priority order relationship is “A>B>C”. Also, in this case, for example, the display guarantee setting value of the content information A is set to “15 seconds”, the display guarantee setting value of the content information B is set to “10 seconds”, and the display guarantee setting value of the content information C is set to “5 seconds”. Also, in this example, it is configured such that the display guarantee setting value is increased (lengthened) as the display priority order of the content information is higher. However, it may not be configured to increase the display guarantee setting value as the display priority order of the content information is higher.

Also, in the case of the fourth embodiment, it is unnecessary to register the user's display integration value and the total display integration value in the content information database 2b. Instead of that, the display priority order is associated with and registered in the content ID of the content information of the time count target. However, in a case where only one piece of the content information of the time count target is arranged on the web page, it is unnecessary to set the display priority order of the content information.

First, a case where the system control unit 27 of the user terminal T1 performs processing illustrated in FIG. 10 will be described below. Also, in this case, the display guarantee setting value and the display priority order are described in the structured document file of the web page, which is transmitted from the information providing server SA to the user terminal T1, in association with the content ID of each piece of the content information of the time count target arranged on the web page. Then, the processing illustrated in FIG. 10 is started in the user terminal T1 when it is determined by the system control unit 27 that the content information of the time count target is displayed within the display area of the window screen on which the corresponding web page is displayed. When the processing illustrated in FIG. 10 is started, the system control unit 27 specifies the content information of the time count target displayed within the display area of the window screen (step S81).

Then, the system control unit 27 acquires the display guarantee setting value of the specified content information of the time count target (that is, the display guarantee setting value associated with the content ID) from the structured document of the corresponding web page (step S82). Also, in step S81, when a plurality of pieces of content information of the time count target is specified, the system control unit 27 acquires the display priority order of each piece of the content information (that is, display priority order associated with the content ID) from the structured document of the corresponding web page.

Then, the system control unit 27 resets the count value of the content information of the time count target, and starts counting the display time of the content information of the time count target (step S83). In step S81, when a plurality of pieces of content information of the time count target is specified, the display time count of each piece of the content information is performed.

Then, the system control unit 27 determines whether a user operation to shift the content information of the time count target to the outside of the display area is detected (step S84). Then, when it is determined that the operation to shift the content information of the time count target to the outside of the display area is not detected (NO in the step S84), the system control unit 27 proceeds to step S87. Also, in other processing illustrated in step S87, for example, processing according to other user operation is performed, and a detailed description thereof will be omitted.

On the other hand, when it is determined that the user operation to shift the content information of the time count target to the outside of the display area is detected (YES in the step S84), the system control unit 27 proceeds to step S85. In step S85, the system control unit 27 determines whether the count value of the display time of the content information of the time count target exceeds the display guarantee setting value of the corresponding content information. Also, in step S81, when a plurality of pieces of content information of the time count target is specified, the system control unit 27 determines whether the count value of the display time of each piece of the corresponding content information exceeds the display guarantee setting value of each piece of the corresponding content information. For example, in a case where the count of the display time of the above-described content information A to C is started at the same time, it is determined that the count value for the content information B and C exceeds the display guarantee setting value when the count value corresponds to “11 seconds” at the time of the determination of the step S85. Therefore, it is excluded from the following continuous displaying processing.

Then, the system control unit 27 performs the continuous displaying processing on the content information that is determined in the step S85 that the count value of the display time thereof does not exceed the display guarantee setting value (step S86). In the continuous displaying processing, as in the continuous displaying processing of the step S28 illustrated in FIG. 6, the processing of continuing the continuous or intermittent displaying of the corresponding content information within the display area is performed. In a case where there is a plurality of pieces of content information whose count value of the display time does not exceed the display guarantee setting value, the continuous displaying processing is performed based on the display priority order (or display priority degree) of each piece of the content information, which is acquired in the step S82. For example, in a case where the count value of the display time of each piece of the above-described content information A to C does not exceed the display guarantee setting value and the content information A is shifted to the outside of the display area by the scroll of the web page, the system control unit 27 replaces the content information A and the content information C displayed within the display area (that is, the displaying of the content information A is continued by replacing it with the content information C having the lowest display priority order).

Alternatively, for example, in a case where the count value of the display time of each piece of the above-described content information A to C does not exceed the display guarantee setting value and the content information A to C is shifted to the outside of the display area by the scroll of the web page, the system control unit 27 redisplays the content information A whose display priority order is “ranking No. 1” at first (e.g., by insertion to be described below). Then, the content information B whose display priority order is “ranking No. 2” is redisplayed, and the content information C whose display priority order is “ranking No. 3” is finally redisplayed. Next, a case where the system control unit 4 of the information providing server SA performs the processing illustrated in FIG. 10 will be described below. In this case, when the web page provided from the information providing server SA to the user terminal T1 (web page on which the content information of the time count target is arranged) is displayed on the screen window of the user terminal T1, coordinate information for defining the display area of the web page displayed on the window screen, for example (e.g., coordinate information of the web page corresponding to positions of four edges of the window screen) is repetitively transmitted from the user terminal T1 to the information providing server SA at predetermined period. The transmission of the coordinate information is also performed during the scroll of the web page by the scroll operation. Therefore, the system control unit 4 of the information providing server SA can determine which range of the web page is currently displayed. Then, the processing illustrated in FIG. 10 is started when it is determined by the system control unit 4 (based on the coordinate information) that the content information of the time count target is displayed within the display area of the window screen on which the corresponding web page is displayed in the user terminal T1. When the processing illustrated in FIG. 8 is started, the system control unit 4 specifies the content information of the time count target displayed within the display area of the window screen (step S81).

Then, the system control unit 4 acquires the display guarantee setting value of the specified content information of the time count target (that is, the display guarantee setting value associated with the content ID) from the content information database 2b (step S82). Also, in step S81, when a plurality of pieces of content information of the time count target is specified, the system control unit 4 acquires the display priority order of each piece of the content information (that is, display priority order associated with the content ID) from the content information database 2b. Then, as in the system control unit 27, the system control unit 4 performs the processing of steps S84 and S85. Then, in the continuous displaying processing illustrated in step S86, the system control unit 4 transmits execution command information to continue the continuous or intermittent displaying of the content information that is determined in the step S85 that the count value of the display time thereof does not exceed the display guarantee setting value. The user terminal T1 receiving the execution command information performs the above-described continuous displaying processing with respect to the content information that does not exceed the display guarantee setting value. Also, in a case where there is a plurality of pieces of content information whose count value of the display time does not exceed the display guarantee setting value, the display priority order of each piece of the content information is included in the execution command information. In this way, in the user terminal T1, the continuous displaying processing is performed based on the display priority order of each piece of the content information.

As described above, according to the fourth embodiment, the continuous displaying of the content information of the time count target can be efficiently performed based on the display priority order (or display priority degree) even when a plurality of pieces of content information of the time count target is included in the web page. Also, control can be performed such that the display time of the content information wanted to be preferentially displayed on the web page even to the unlogged user exceeds the time desired by the provider of the content information or comes close to the time as much as possible.

Next, modifications of the first to fourth embodiments will be described separately in first to third modifications.

(Modification 1)

In the processing illustrated in FIG. 6, FIG. 9 or FIG. 10, the system control unit 27 may be configured to, after starting counting the display time of the content information of the time count target, determine whether the time when the user operation is not performed on the display area of the window screen displaying the corresponding content information exceeds the preset count upper limit, and stop counting the display time of the content information of the time count target according to the excess over the count upper limit. According to this configuration, after the web page is displayed, for example, in a case where the web page is left by the user as it is, it is possible to prevent the display time from being unnecessarily counted at the time for which the web page is left as it is (that is, the time when the web page is not browsed by the user). Also, the count upper limit may be configured to be set based on, for example, a volume of other content information displayed within the display area together with the content information of the time count target. For example, as illustrated in FIG. 7A, in a case where the video content information 61 is arranged on the web page, the count upper limit is set according to a time length (total replay time) of a video and a volume of a text. For example, a video time length “10 minutes”+text “1 minute”=11 minutes are set as the count upper limit. Herein, the video time length “10 minutes” is included because all browsing of the user from the replay start to the replay end has been considered. Also, the text “1 minute” is included because the time necessary for the user to read the text has been considered. Also, instead of the video time length “10 minutes”, an actual video replay time may be considered. In this case, actual video replay time “3 minutes”+text “1 minute”=4 minutes are set as the count upper limit. In this way, when the count upper limit is configured to be set based on the volume of the content information, it is possible to increase the accuracy as the time estimated as being browsed by the user. Also, if there is the user operation again after the count is stopped according to the excess over the count upper limit, it is configured such that the count value counted up to the upper limit is reset and the count of the display time is resumed.

(Modification 2)

In the processing illustrated in FIG. 6, FIG. 9 or FIG. 10, the system control unit 27 may be configured to stop counting the display time of the content information of the time count target according to the change of the web page, on which the content information of the time count target is arranged, (that is, display area of the content information of the time count target) from an active state to an inactive state. For example, in the example illustrated in FIG. 7A, an “information retrieval” tab 71 is selected and the web page of the information retrieval is displayed on the window screen in an active state. However, when the web page of the information retrieval becomes an inactive state by the user's selection of a “shopping” tab 72, the count of the display time of the content information of the time count target arranged on the corresponding web page is stopped. According to this configuration, since the web page being in the inactive state is considered as not being browsed by the user, it is possible to prevent the display time from being unnecessarily counted. Also, when a plurality of window screens is displayed in an overlapped manner, the web page displayed on the window screen located at the forefront is in an active state. The count of the display time is configured to be resumed in a case where the display area of the content information of the time count target becomes an active state again after the count is stopped according to the excess over the count upper limit.

(Modification 3)

In the processing illustrated in FIG. 6, FIG. 9 or FIG. 10, the system control unit 27 may be configured to calculate the speed of the scroll of the display content including the content information of the time count target displayed in the display area of the window screen, and stop counting the display time of the content information of the time count target when the speed of the scroll is equal to or less than a predetermined speed (in other words, stop counting the display time when the speed of the scroll is faster than a predetermined speed). According to this configuration, since it is considered that the web page is not browsed slowly when the speed of the scroll is faster than the predetermined time, it is possible to prevent the display time from being unnecessarily counted. Also, the speed of the scroll, for example, can be calculated by dividing a moving amount of an arbitrary pixel on the web page displaced by the scroll by the time necessary for the movement (scroll duration time). Also, for example, when an arbitrary pixel displayed on the window screen is moved from first coordinates (x1, y1) to second coordinates (x2, y2), with the left upper end of the screen window as the origin, the “moving amount” corresponds to a distance between the first coordinates and the second coordinates.

Also, in the embodiment, although the display unit which is included in the user terminal Tn has been provided as an example of the “displaying mans”, an external display which is not included in the user terminal Tn may be the displaying means.

### REFERENCE SIGNS LIST

1 communication unit
2 storage unit
3 input/output interface unit
4 system control unit
5 system bus
21 operation unit
22 display unit
23 communication unit
24 drive unit
25 storage unit
26 input/output interface unit
27 system control unit
28 system bus
Tn user terminal
SA information providing server
NW network

1-14. (canceled)

15. An information processing apparatus comprising:
a counting means that counts a display time for which content information preset as a count target of a display time is displayed within a display area of a displaying means; and
a display controlling means that continuously or intermittently displays the content information within the display area until the display time counted by the counting means exceeds a set time preset to the content information.

16. The information processing apparatus according to claim 15,
wherein the content information is transmitted from a server device for which sessions are established with a terminal device including the displaying means,
the information processing apparatus further comprises a first integrating means that integrates the display time, which is counted by the counting means, over the sessions, and
the display controlling means continuously or intermittently displays the content information within the display area until the display time integrated by the first integrating means exceeds the set time.

17. The information processing apparatus according to claim 15, further comprising:
an acquiring means that acquires the display time counted by the counting means and user identification information for identifying a user of a terminal device, from the terminal device including the displaying means; and
a second integrating means that integrates the display time acquired by the acquiring means in association with the user identification information, and
the display controlling means continuously or intermittently displays the content information within the display area of the terminal device associated with the user identification information until the display time integrated by the second integrating means exceeds the set time.

18. The information processing apparatus according to claim 17,
wherein the set time to be compared with the display time integrated by the second integrating means is set to more than a minimum time necessary when the user browses the content information.

19. The information processing apparatus according to claim 15, further comprising a third integrating means that integrates the display time, which is counted by the counting means, while being gathered by a plurality of users,
wherein the display controlling means continuously or intermittently displays the content information within the display area until the display time integrated by the third integrating means exceeds the set time.

20. The information processing apparatus according to claim 15,
wherein the content information is arranged on the web page displayed in the display area, and
when there is a user operation to shift the content information to the outside of the display area in a state in which the displaying of the web page is maintained, the display controlling means continuously or intermittently displays the content information within the display area until the display time counted by the counting means exceeds the set time.

21. The information processing apparatus according to claim 16,
wherein the content information is arranged on the web page displayed in the display area, and
when there is a user operation to shift the content information to the outside of the display area in a state in which the displaying of the web page is maintained, the display controlling means continuously or intermittently displays the content information within the display area until the display time counted by the counting means exceeds the set time.

22. The information processing apparatus according to claim 17,
wherein the content information is arranged on the web page displayed in the display area, and
when there is a user operation to shift the content information to the outside of the display area in a state in which the displaying of the web page is maintained, the display controlling means continuously or intermittently displays the content information within the display area until the display time counted by the counting means exceeds the set time.

23. The information processing apparatus according to claim 19,
wherein the content information is arranged on the web page displayed in the display area, and
when there is a user operation to shift the content information to the outside of the display area in a state in which the displaying of the web page is maintained, the display controlling means continuously or intermittently displays the content information within the display area until the display time counted by the counting means exceeds the set time.

24. The information processing apparatus according to claim 15,
wherein the counting means stops counting the display time when a time for which a user operation is not performed on the display area displaying the content information exceeds a preset count upper limit.

25. The information processing apparatus according to claim 21,
wherein the count upper limit is set based on a volume of other content information displayed within the display area together with the content information.

26. The information processing apparatus according to claim 19,
wherein the third integrating means integrates the display time counted by the counting means for each user of terminal devices including the displaying means, and
the counting means stops counting the display time of the content information displayed within the display area of the terminal device of the user, for which the display time integrated by the third integrating means for each user exceeds a preset count upper limit.

27. The information processing apparatus according to claim 15,
wherein the counting means stops counting the display time according to a change of the display area, in which the content information is displayed, from an active state to an inactive state.

28. The information processing apparatus according to claim 16,
wherein the counting means stops counting the display time according to a change of the display area, in which the content information is displayed, from an active state to an inactive state.

29. The information processing apparatus according to claim 17,
wherein the counting means stops counting the display time according to a change of the display area, in which the content information is displayed, from an active state to an inactive state.

30. The information processing apparatus according to claim 19,
wherein the counting means stops counting the display time according to a change of the display area, in which the content information is displayed, from an active state to an inactive state.

31. The information processing apparatus according to claim 15,
wherein the counting means counts the display time when a speed of a scroll of display content including the content information displayed in the display area is equal to or less than a predetermined speed.

32. The information processing apparatus according to claim 16,
wherein the counting means counts the display time when a speed of a scroll of display content including the content information displayed in the display area is equal to or less than a predetermined speed.

33. The information processing apparatus according to claim 17,
wherein the counting means counts the display time when a speed of a scroll of display content including the content information displayed in the display area is equal to or less than a predetermined speed.

34. The information processing apparatus according to claim 19,
wherein the counting means counts the display time when a speed of a scroll of display content including the content information displayed in the display area is equal to or less than a predetermined speed.

35. An information processing method, which is executed by a computer, the information processing method comprising:
a step of counting a display time for which content information preset as a count target of a display time is displayed within a display area of a displaying means; and
a step of continuously or intermittently displaying the content information within the display area until the counted display time exceeds a set time preset to the content information.
